(19) United States
(12) Patent Application Publication
(10) Pub. No.: US 2010/0145727 A1
(43) Pub. Date: Jun. 10, 2010

(54) INTERACTION BETWEEN HEALTHCARE SOFTWARE PRODUCTS

(75) Inventors: Keith Maurice Toussaint, Seattle, WA (US); Minakshi Krishna Velamoor, Redmond, WA (US); Kimberly Luu, Windsor (CA); Puneet Nagpal, Redmond, WA (US); John Arthur Hancock, Rockville, MD (US); Alex Byung-Hoon Yu, Fairfax, VA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/330,479

(22) Filed: Dec. 8, 2008

(51) Int. Cl. G06Q 50/00

(52) U.S. Cl. 705/3

(57) ABSTRACT

Patient records may be maintained in healthcare software systems, and two healthcare software systems may communicate to exchange information about a patient. In one example, one of the systems is a provider-oriented system used by a provider such as a hospital, doctor's office, etc., and the other system is a patient-oriented system that the patient uses to manage his or her healthcare records. The patient and the provider may exchange information to allow the systems to communicate with each other. The provider's system may then receive information from the patient's system. The data provided by the patient's system may be voluminous, and the provider's system may extract specific information from that data, and may place the extracted data in a flat data structure.

### BACKGROUND

There are various software systems that are used in the service of healthcare. There are provider-oriented systems used in hospitals, doctors offices, etc., which are often used to manage patient records and/or technical medical information, such as radiology reports, cardiograms, etc. Additionally, there are systems that help patients to manage their own healthcare records. Some patients may use these systems to collect an overall picture of their healthcare data. That healthcare data may be collected from, and/or used by, different healthcare providers.

In some cases, there may be reason for one system to collect information from another system. For example, there may be reason for a provider's healthcare software to collect information from the patient. The patient may maintain this information in a consumer-oriented system to which the patient subscribes. In such a case, the provider may want to use its software to obtain the patient's healthcare data from the software that the patient uses.

### SUMMARY

Two healthcare software systems, such as a provider-oriented system may communicate with each other regarding a patient's healthcare information. In one example, one of the healthcare software systems is a provider-oriented system, and the other is a patient-oriented system. Thus, a patient may maintain an account with a patient-oriented system, and the healthcare provider's system (e.g., a system maintained by a hospital, doctor's office, etc.) may receive the patient's healthcare records or other information from the patient's account on the patient-oriented system.

Various formats exist to store and transfer healthcare records, such as the Continuity of Care Record (CCR) format. This format tends to provide many different types of healthcare data about a patient in a complex format. One system may receive information from another system in CCR format (or some other format), and then may select a certain subset of the information—e.g., based on criteria such as the likelihood that the selected information will later be used. The selected information may be stored in one or more flat data structures. The system that receives the information may be extensible by scripting. The selection of the information, and/or the conversion of the information to a flat format, may be performed by a script that is added to the system.

Prior to the transfer of information from one system to another, the patient and the provider may exchange appropriate informationFor example, each system may maintain an identifier for a patient, and information may be exchanged to allow the systems to associate each other's identifiers with the same patient.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example scenario in which information may be transferred between two healthcare software systems.

FIG. 2 is a flow diagram of an example process in which sharing of information between two healthcare software systems may be set up and/or performed.

FIG. 3 is a block diagram of an example scenario in which one system provides healthcare information to another system.

FIG. 4 is a flow diagram of a process in which one system may process data retrieved from another system.

FIG. 5 is a block diagram of example components that may be used in connection with implementations of the subject matter described herein.

### DETAILED DESCRIPTION

Many software systems are used in the service of healthcare. Different software systems address different aspects of the healthcare field. For example, one system could focus on serving healthcare providers such as hospitals and doctors' offices, and another system could focus on healthcare consumers (e.g., patients). Sometimes there is reason for these systems to share information. A provider's healthcare software may maintain various types of information about a patient's health (e.g., blood pressure readings, images from radiological examinations, history of treatment, etc.). The patient may use a patient-oriented software system, and may wish to obtain some information relating to his or her health care from the provider's system. Additionally, the patient may use the patient-oriented software to maintain information that the patent would like to make available to a healthcare provider (e.g., blood glucose readings taken at home, as part of the patient's treatment for diabetes, or test results obtained from one provider that the patient would like to make available to another doctor).

The subject matter described herein provides techniques in which one healthcare software system may interface with another, so that one system may provide information to, and/or receive information from, the other system.

An example of provider-oriented healthcare software is the MICROSOFT AMALGA system, and an example of patient-oriented healthcare software is the MICROSOFT HEALTHVAULT system. The subject matter described herein may be used to allow the MICROSOFT AMALGA system to provide information to, and obtain information from, the MICROSOFT HEALTHVAULT system. However, the subject matter herein may also be used with other software systems.

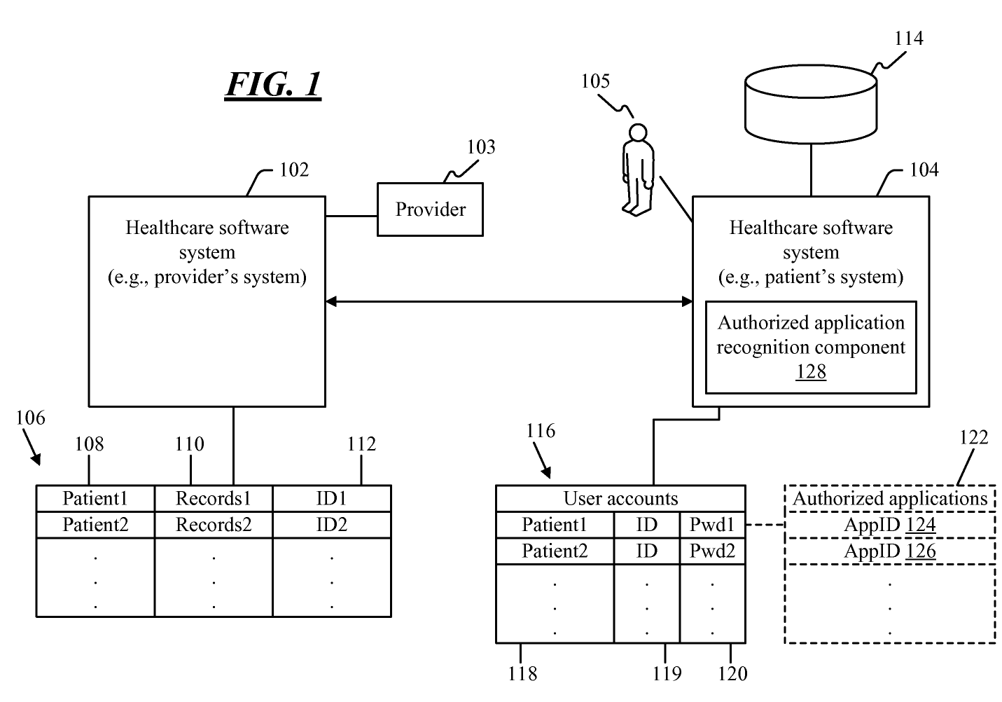

Turning now to the drawings, FIG. 1 shows an example scenario in which information may be transferred between two healthcare software systems. The example shown includes healthcare software system 102 and healthcare software system 104. As one example, healthcare software system 102 may be a provider-oriented system (such as the MICROSOFT AMALGA system), and healthcare software system 104 may be a patient-oriented system (such as the MICROSOFT HEALTHVAULT system). However, healthcare software systems 102 and 104 could be any kinds of systems. Healthcare system 102 may be associated in some manner with healthcare provider 103, and system 104 may be associated in some manner with patient 105. (For example, system 102 could be owned or operated by provider 103, and system 104 could be subscribed to by patient 105; however, the association between a system and an entity could take any form.)

In the example where system 102 is a provider-oriented system, system 102 may be used in a healthcare provider's setting (e.g., a doctor's office, a hospital, etc.), and may manage various information related to one or more patients. For example, system 102 may collect pieces of healthcare information of different types (e.g., radiology reports, cardiograms, blood test results, etc.), and may include various capabilities to store, analyze, and/or present this information.

One feature of system 102 is that it may maintain a database 106 that associates patients and their records. In the example of FIG. 1, database 106 is shown as a table that associates patients 108 with records 110 and identifiers 112, although database 106 could take any form. For example, the first line of the table shows that “patient1” is associated with “records1” and “ID1”; similar associations are shown by the second and subsequent lines. (Identifiers 112 may be used to connect a patient's records in system 102 with the same patient's records in system 104. Identifiers 112, and their use, will be discussed below.)

System 104, as noted above, may be a provider-oriented system. System 104 may store information about patients' healthcare in database 114. System 104 may use login credentials, or some other form of authentication, to gate access to a given patient's information. Thus, for example, if a patient accesses his or her records with an identifier and a password, then system 104 may maintain a list 116 of user accounts, which associates patients 118, and their internal identifiers 119, with passwords 120. (As discussed below, system 102 may access a patient's records in system 104 without using the patient's credentials.) In addition to associating an identifier and password combination with a particular patient, system 104 may also maintain a list of applications that may be used with a patient's account. In one example, system 104 provides a platform to maintain a patient's healthcare information, and the actual acts of using and obtaining that information are provided through applications that interact with system 104. A patient may authorize the use of a particular application with his or her information. Thus, system 104 may maintain, for each patient, a list 122 of applications that may be used with a patient's information. Each authorized application may, for example, have an application identifier. For example, the patient labeled “patient 1” in list 116 indicates that “patient 1” has authorized the use of the applications have identifiers 124 and 126. System 104 may comprise a component 128 that recognizes which applications are allowed to access a patient's information. E.g., when an application attempts to connect to system 104 and to access a patient's information, component 128 may compare the application's identifier with the list 122 of applications authorized by that patient. Component 128 may then determine, based on the list and by the identifier provided by the application, whether the application that is requesting access has been authorized to access the patient's records.

When information is to be transferred between systems 102 and 104, system 102 may connect to system 104 through a particular application. The identifier of the application that is used may appear on list 122, and that fact that the application's identifier appears on list 122 may be taken as an indication that a given patient has authorized the use of that application with his or her information. The process by which the application's identifier is communicated to system 104 will be further discussed below. When system 102 contacts system 104 to obtain patient records, system 102 may use an application that has a particular application identifier. System 102 may use the same application (and application identifier) regardless of which patient's records system 102 is accessing. However, those patients that have agreed to allow system 102 to access their records within system 104 may have this particular application listed (by its application ID) in their records as an authorized application. When the application contacts system 104 to obtain records for a patient, it may identify the patient whose records it is asking for (e.g., using one of identifiers 119). (An example process by which system 102 learns of the internal identifiers 119 for patients in system 104 is described below.)

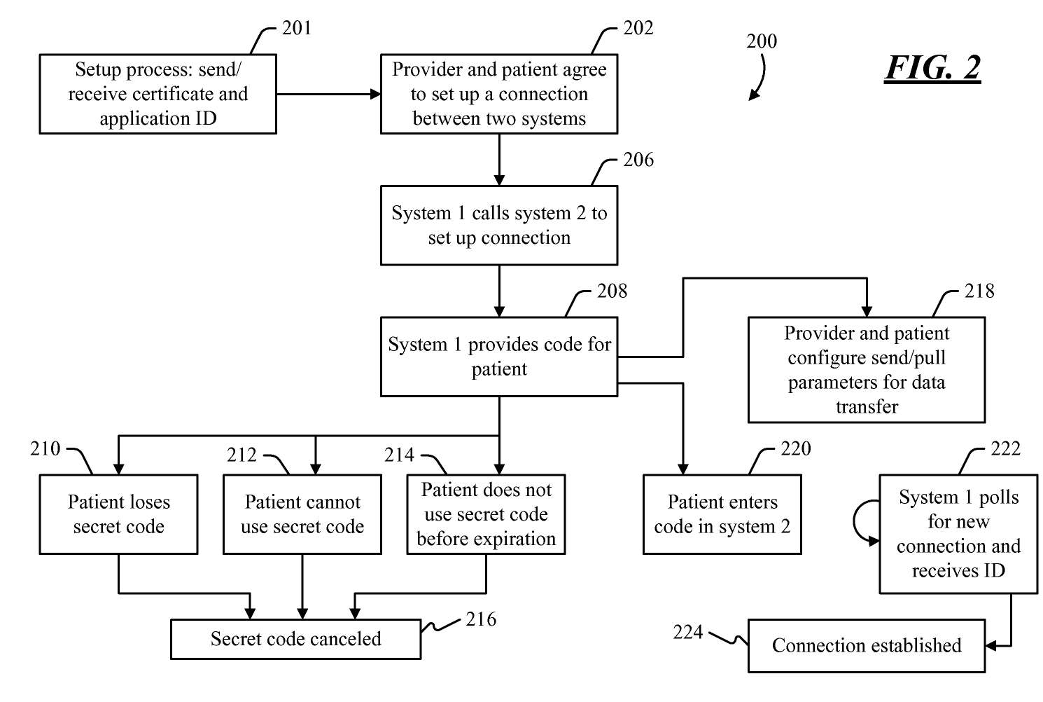

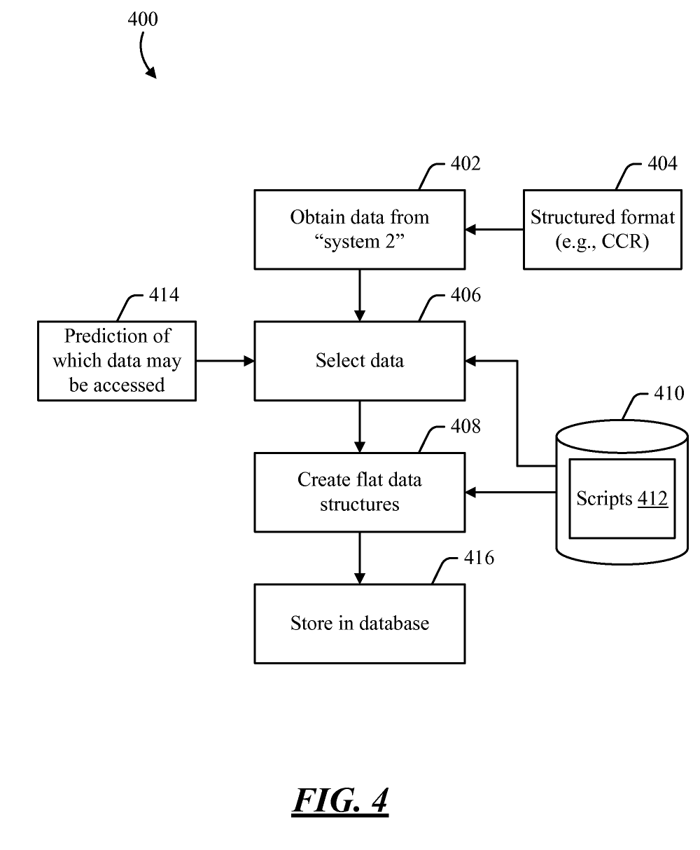

FIG. 2 shows an example process 200 in which sharing of information between two healthcare software systems may be set up and/or performed. The two systems may, for example, be a provider-oriented system and a patient-oriented system (e.g., systems 102 and 104, shown in FIG. 1). However, process 200 could be performed using any system(s). Moreover, it is noted that each of the flow diagrams herein (the flow diagram of FIG. 2, as well as the subsequently-described flow diagram of FIG. 4) shows an example in which stages of a process are carried out in a particular order, as indicated by the lines connecting the blocks, but the various stages shown in these diagrams may be performed in any order, or in any combination or sub-combination.

At 201, a setup process may be performed, that may allow future interaction between two systems. (In FIG. 2, the two systems that interact with each other are referred to as “system 1” and “system 2”. “System 1” may be the provider-oriented system, and “system 2” may be the patient-oriented system.) The setup process may involve the sending/receipt of a certificate and an application identifier. One example of such a setup process may be described as follows:
“System 1” may create a certificate, which may be sent to “system 2”;
“System 2” may store the certificate, and may generate an application identifier for the application that “system 1” will use to access patient information in “system 2”;
When “system 1” submits a request to “system 2” for patient information, “system 1” authenticates itself by providing the application identifier and certificate (to which only “system 1” has access).
   From this point, “system 2” will recognize the certificate and the application identifier, in order to recognize “system 1's” legitimate attempts to access data in “system 2”. Thus, the foregoing process of providing a certificate and an application identifier allows “system 1” to obtain access to patient records in “system 2”.

At 202, a healthcare provider and a patient may agree to set up a connection between their respective systems, in order to allow these systems to exchange the patient's information.

At 206, one system calls another system to set up a connection. During this call, “system 1” may send, to “system 2”, the identifier that “system 1” uses to identify the patient within its system (e.g., one of identifiers 112, shown in FIG. 1). At 208, “system 1” may provide, to the patient, a code that “system 2” obtained from “system 1.” This code may later be used by the patient in a manner described below. For example, the code provided may be the number “12345”. This number may have been generated by “system 2” as part of the above-mentioned call in which the connection between the systems was set up. “System 1” may receive this number from “system 2”, and “system 1” (or the operator of “system 1”) may then provide this code to the patient, with instructions to use the code during a subsequent contact that the patient makes with “system 2”.

Before turning to a discussion of how the secret code is used, it is noted that there are various example scenarios in which the code is not used. Examples of these scenarios are shown at 210-214. For example, the patient may lose the code (at 210). Or the patient (e.g., due to technical difficulties within the system in which the patient tries to enter the code) may be unable to use the code (at 212). Or, the code may have an expiration date, and that date may have passed before the patient attempts to use the code (at 214). If any of these scenarios occur, the code may be canceled (at 216). If the code is canceled, the patient and the provider may interact again (e.g., by performing one or more of the stages described at 202-208) so that the patient may be issued another code.

If the scenarios shown at 210-214 do not come to pass, then process 200 proceeds to 218 and/or 220. At 218, the provider and patient may configure send/pull parameters for transfer of information between their respective systems. (Or, the parameters for send/pull may apply system-wide to all transactions between the two systems, and thus may have been configured during an initial system setup process.) The parameters may specify the time and/or conditions at which transfer of information is to take place—e.g., the transfer may take place on a timed schedule, in response to certain types of events, on the demand of one of the parties, etc. There may be a set of default parameters (e.g., initiate a transfer once per day at 2:00 a.m.), so that transfers may proceed on some terms even if 218 is omitted.

At 220, the patient may enter, into “system 2”, the code that was provided at 208. This code may be the code that “system 2” provided to “system 1” when the call between the two systems was made (at 206) to set up a connection. When the patient enters the code, “system 2” may use the code to access the connection request that was initiated at 206. It will be recalled that “system 2” may have received, from “system 1,” the identifier that “system 1” uses to identify the patient for whom the code was issued. Thus, when the patient enters that same code and signs into “system 2,” “system 2” knows that the patient who is signed in is the same patient whose identifier in “system 1” was previously received. Thus, “system 2” can now associate a particular patient with the patient identifier that had been received.

At some point in time, “system 1” may poll for new authorized connections (at 222). As indicated by the arrow looping back to 222, this polling may occur until a connection is detected. Once a connection has been detected, a connection is established (at 224). “System 1's” access to the patient information in “system 2” may be authorized based on the certificate that system 1's application provides to system 2, and based on the fact that a particular patient has authorized the use of that application to access his or her records. (As noted above, the fact that a patient has authorized an application to access his or her records may be indicated by the fact that the application's identifier has been placed in list 122 (shown in FIG. 1). After the foregoing has occurred, the exchange of information may begin.

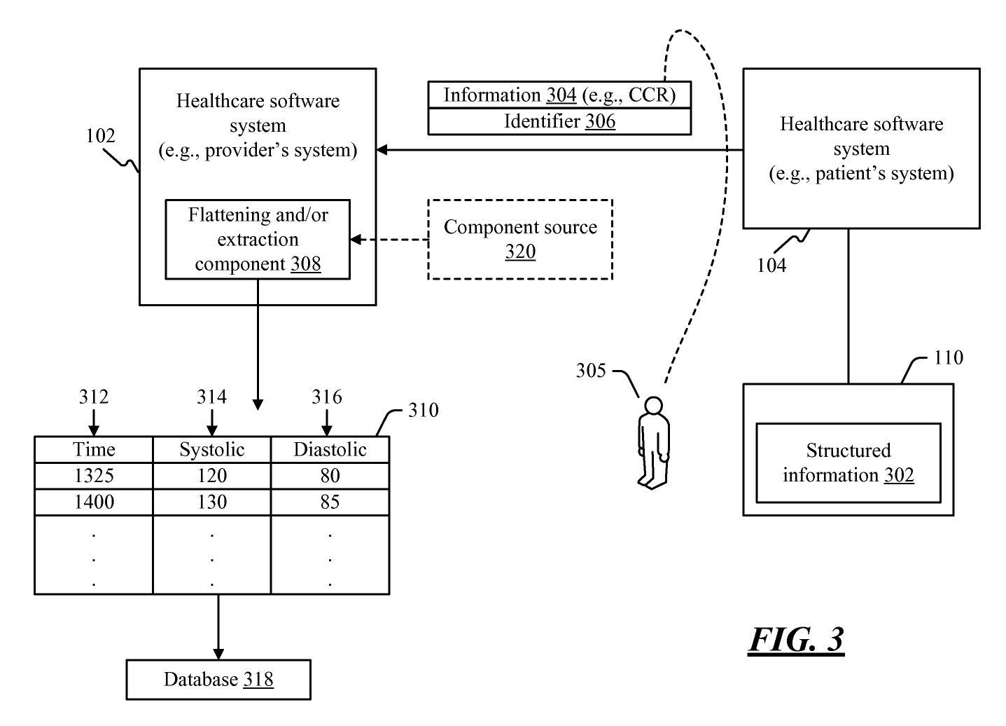

FIG. 3 shows an example scenario in which one system provides healthcare information to another system. As in FIG. 1, FIG. 3 shows systems 102 and 104, which may be, for example, provider-oriented and patient-oriented healthcare software systems, respectively.

As described above in connection with FIG. 1, system 104 may store records 110 relating to a patient's healthcare. These records may take the form of structured information 302. For example, the Continuity of Care Record (CCR) format allows patient records to be represented in a structured way. CCR is defined as an extensible Markup Language schema, and thus represents certain information, and the relationship among that information, in an intricate tree structure (which is an example of a non-flat structure). System 104 may store a patient's record in CCR format (or in some other structured form), or may be able to convert an internal form of a patient record into a structured format like CCR.

Using, for example, the structures and procedures described above, system 104 may provide information 304 about a patient's healthcare to system 102. (Information 304 is sometimes referred to herein as “data” or “healthcare data”.) Information 304 may relate to a particular patient 305. For example information 304 may be descriptive of, or may otherwise relate to, patient 305's human body, or to a physical test and/or examination that has been performed on that body. In one example, system 104 provides this information in CCR format, although the information could be provided in any format (e.g., system 104 could provide the information in its native data types, and system 102 could be configured to use these data types). Moreover, when providing the information, system 102 may associate identifier 306 with the information. Identifier 306 may be the identifier that one of the systems uses to identify a particular patient. For example, as noted above, system 104 may learn—through an initial connection process, as described in FIG. 2—what identifier system 102 uses to identify a particular patient. Moreover, as also described above in connection with FIG. 2, when a patient enters a secret code that has been provided and then signs in, system 104 may learn which patient in system 104's own records is associated with that identifier. Thus, when system 104 provides patient information to system 102, system 104 may add, to that information, the identifier that system 102 associates with that patient. Identifier 106 may be that identifier that system 102 associates with the patient whose information 304 is being provided.

System 102 may receive information 304 and identifier 306. (For example, information 304 may comprise, or be accompanied by, identifier 306.) System 102 may comprise, or otherwise use, a flattening and/or extraction component 308 which may extract and/or reformat incoming information 304. (Flattening and/or extraction component 308 could take any form—e.g., a script, executable code, etc.) For example, many formats for representing patient health data (e.g., CCR) may allow a large amount or variety of data to be represented in an intricate tree structure. The size of the information, and the complexity of its representation, may make the information inefficient to work with. Thus, flattening and/or extraction component 308 may extract some data from information 304, and may place the extracted data in a particular format (e.g., a flat table format), which may simplify working with the data. For example, a blood pressure record might containing data such as the time the blood pressure reading was taken, the systolic and diastolic pressures, notes by the physician or nurse who took the reading, the type of equipment used to take the reading, or other information. However, a user of system 102 may be particularly interested in having a table with the time of the reading and the systolic/diastolic values. Thus, flattening and/or extraction component 308 could extract the time and systolic/diastolic values from the incoming information 304, and could generate one or more flat tables containing that information. FIG. 3 shows an example table 310, which is an example representation of blood pressure data that has been extracted from information 304. Table 310 contains columns 312, 314, and 316, showing the time, the systolic reading, and the diastolic reading, respectively. After generating table 310, system 102 may store table 310 in database 318, where it may later be used by system 102 (or in applications built on a platform provided by system 102) to look up a patient's blood pressure readings.

System 102 may be extensible in the sense that components can be added to system 102. For example, system 102 may support a scripting function that allows components to be added to system 102 at runtime, without rebuilding the software on which system 102 is based. Flattening and/or extraction component 308 may be an example of a component that can be added to system 102 in this manner. Thus, flattening and/or extraction component 308 may come from a component source 320. Component source 320 may be, for example, a third-party provider of software components (e.g., scripts), although component source 320 could be any entity. (E.g., component source 320 might be a “third-party” in the sense that the party that provides a component may be different from the party that provides the executable instructions or other software that make up system 102.) By providing such extensibility, system 102 may be able to adapt to changes, such as changes in the format of information 304, or changes in the type of information that users of system 102 want to have in a flat format. For example, a new type of medical test could be created. The CCR format could be extended to be able to represent data about the results of this test. Applications built on the platform provided by system 102 might want to have this new data in a flattened form, so that the data can easily be used by the applications. Thus, component source 320 could provide a new flattening and/or extraction component that is able to recognize this new type of incoming information, and that is able to extract particular portions of that information to be put into one or more flat data structures.

FIG. 4 shows, in the form of a flow chart, a process 400 in which one system may process data retrieved from another system. At 402, one system (e.g., system 102, shown in FIG. 1) obtains data from another system (e.g., system 104 shown in FIG. 1). In the example of FIG. 4, the data that is obtained at 402 is shown as being in a structured format (block 404), although the data could be in any form. The CCR data described above is an example of structured data.

At 406, a subset is selected from among the data that was obtained. For example, as described above in connection with FIG. 3, the data that one system obtains from another could be large and complex, and the system that is obtaining the data might want to extract some portion of the data and/or flatten it into a simple table format. As described above, the systolic/diastolic values of a blood pressure reading, and the time of the reading, could be extracted from a larger set of data about a patient's blood pressure. Extracting that information is an example of selecting a subset of the obtained data.

At 408, a flat data structure may be created from the selected data. For example, as described above, certain data may be selected from a large set of data, and the selected data may be placed in a flat data structure, such as a table. In this sense, the flat data structure may represent a subset of the data, which has been extracted from the larger set of data. The flat data structure may be stored in a database (at 416).

As noted above, the selection of data, and the process of flattening the data, may be driven by a script. A script repository 410 may store the scripts 412 that are used in the selection and/or flattening process. As noted above, the system that obtains, selects, and/or flattens the data may be extensible in the sense that a new script (possibly provided by a third-party) may be added to the system without rebuilding the system.

It is noted that the particular data that is selected at 406 may be chosen based on any criteria. One example criteria is a prediction, or other assessment, that has been made as to which data may be accessed (block 414). As noted above, the data that one system sends to another may contains numerous types of information, even if only some of the information will be used. Thus, the selection of particular data to be placed in flat data structures may be made based on the likelihood that the particular kind of data selected would be accessed by users, or would be used in the course of presenting information related to said patient, or would be used in analyzing some aspect of said patient. In this sense, the selection of particular data to extract from the larger stream of incoming data, and the placing of the selected data in a flat data structure, may be viewed as a type of efficiency for applications that use that data.

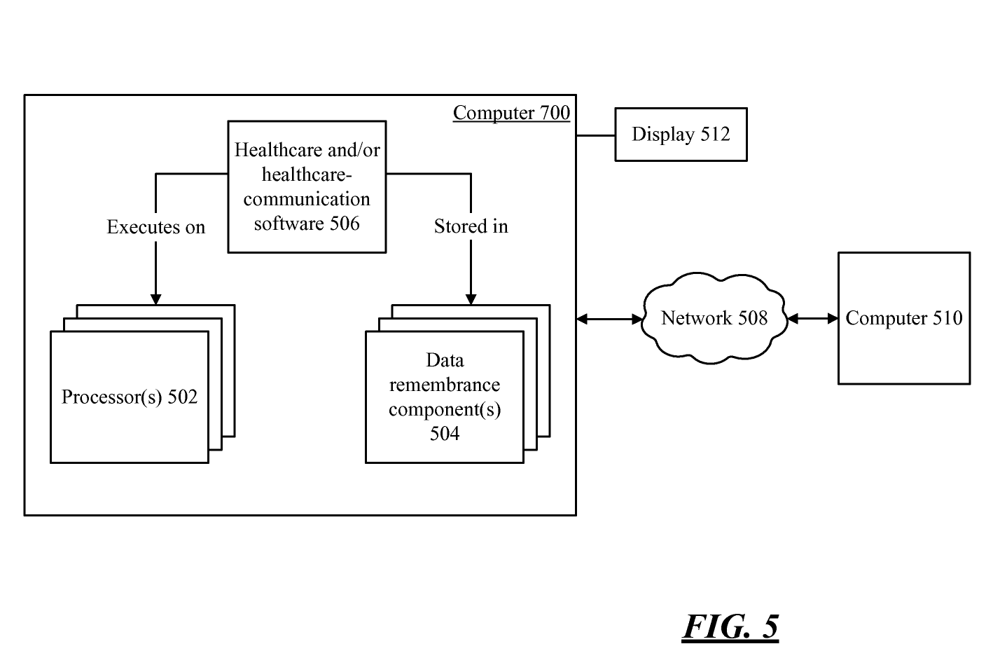

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is healthcare and/or healthcare-communication software 506 (e.g., software that is related to healthcare and/or software that is related to the communication of healthcare-related information), which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A personal computer in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as software having instructions that, when executed by a computer, cause the computer to perform one or more acts of a method, and where the instructions are stored on one or more computer-readable storage media. The instructions to perform the acts could be stored on one medium, or could be spread out across plural media, so that the instructions might appear collectively on the one or more computer-readable storage media, regardless of whether all of the instructions happen to be on the same medium. A particular method could be performed using a processor. Thus, for example, if a method is described herein as “comprising A, B, and C”, then the subject matter herein may also be used to implement a method that comprises using a processor to perform A, B, and C, or a method that comprises using at processor to perform the steps of A, B, and C, or a similar method or process. Moreover, if a particular set of one or more acts, stages, steps, actions, etc., has been described anywhere herein, those same acts, stages, steps, actions, etc., may be performed by a processor. For example, if one of the flow diagrams herein shows blocks that represent the stages A, B, and C, of a process (or if A, B, and C have been described herein in any manner, regardless of whether A, B, and C are stages, steps, acts, actions, etc., and regardless of whether they are shown in a flow diagram), then a method may be performed that comprises using a processor to perform A, B, and C, or that comprises using a processor to perform the steps of A, B, and C (or that comprises using a processor to perform the acts, actions, etc., of A, B, and C).

In one example environment, computer 500 may be communicatively connected to one or more other devices through network 508. Computer 510, which may be similar in structure to computer 500, is an example of a device that can be connected to computer 500, although other types of devices may also be so connected. Computers 500 and 510 may have network interface software and/or hardware that allows each of these computers to communicate through a network.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A first system that receives healthcare data, the first system comprising:
a processor;
a data remembrance component;
healthcare communication software that executes on said processor, that is stored in said data remembrance component, and that obtains, through a network, healthcare data from a second system, said healthcare data relating to a patient, said healthcare communication software obtaining said healthcare data by using a certificate and an application identifier that is exchanged in a setup process and that is recognized by said second system; and
an extraction component that extracts a subset of said healthcare data and that stores said subset in a database.

2. The first system of claim 1, wherein said healthcare data relates to a human body of said patient.

3. The first system of claim 1, wherein said healthcare data is in a first format, and wherein the first system further comprises:
a flattening component that stores said subset in a second format, said first format having a non-flat structure, said second format being one or more flat tables.

4. The first system of claim 1, wherein said first system associates said patient with a code, wherein said patient provides said code to said second system, and wherein said healthcare data comprises, or is accompanied by, an identifier in said first system that said second system determines, through receipt of said code, is associated with said patient.

5. The first system of claim 1, wherein said extraction component chooses said subset based on an assessment that has been made of a likelihood of said subset being subsequently accessed.

6. The first system of claim 1, wherein said first system is extensible through a scripting capability, and wherein said extraction component is implemented as a script that has been added to said first system.

7. The first system of claim 1, wherein said first system obtains said healthcare data from said second system on a schedule specified by said patient.

8. A method of receiving healthcare data at a first system from a second system, the method comprising:
receiving a certificate and an application identifier that allows a healthcare provider to access an account at said second system that is maintained by a patient;
providing a code, which is received by said first system from said second system, and which is entered into said second system by said patient;
connecting to said second system using an application that identifies itself using said application identifier; and
obtaining said healthcare data from said second system at a timing based on parameters established by said healthcare provider and said patient.

9. The method of claim 8, wherein said healthcare data comprises, or is obtained with, a patient identifier that said second system receives from said first system when a connection between said first system and said second system is requested, and wherein the method further comprises:
using said code to determine that said healthcare data relates to said patient.

10. The method of claim 8, further comprising:
selecting a subset of said healthcare data, said subset being selected based on a predication of whether said subset is likely to be used in assessment of said patient or in presentation of information relating to said patient; and
storing said subset in a database.

11. The method of claim 8, wherein said healthcare data is in a non-flat format, and wherein the method further comprises:
storing a subset of said data in a flat format.

12. The method of claim 8, wherein said healthcare data is descriptive of a human body of said patient, or of a physical test or examination performed on said human body.

13. The method of claim 8, further comprising:
receiving a script that selects a subset of said healthcare data or that converts said healthcare data from one form to another form.

14. The method of claim 8, wherein said parameters specify a schedule on which said healthcare data is to be received, or specify an event that triggers obtaining of said healthcare information.

15. One or more computer-readable storage media that store executable instructions that, when executed by a computer, cause the computer to perform a method of processing healthcare data, the method comprising:
obtaining the healthcare data from a system, the healthcare data being in a structured form, said healthcare data relating to a patient;
selecting a subset of said healthcare data based on a criterion, said subset being selected based on an assessment of a likelihood that said subset of said healthcare data will be used in presenting information relating to said patient or in analyzing of said patient;
creating a flat data structure that represents said subset; and
storing said flat data in a database.

16. The one or more computer-readable storage media of claim 15, wherein said healthcare data is descriptive of a physical examination or a test performed on a human body of said patient.

17. The one or more computer-readable storage media of claim 15, wherein the method further comprises:
providing a patient identifier which, after said providing, is received as part of, or with, said healthcare data.

18. The one or more computer-readable storage media of claim 17, wherein an application that obtains said healthcare data from said system uses said code to identify said application to said system.

19. The one or more computer-readable storage media of claim 15, wherein the method further comprises: configuring parameters governing when said healthcare data is to be obtained, said healthcare parameters specifying a schedule on which said healthcare data is to be communicated, or specifying an event upon which said healthcare data is to be communicated, or specifying that said healthcare information is to be submitted upon an entity's demand.

20. The one or more computer-readable storage media of claim 15, wherein a script is used to select said subset, said script having been provided by a third-party source that is not a provider of said executable instructions.
